(19) United States
(12) Patent Application Publication
(10) Pub. No.: US 2026/0134010 A1
(43) Pub. Date: May 14, 2026

(54) SYSTEM FOR GENERATING AN EVENT-DERIVED TEXT-BASED NARRATIVE AND METHOD OF USE THEREOF

(71) Applicant: GENETEC INC., St-Laurent (CA)

(72) Inventors: Christopher Rooney, Cheadle (GB); Neesha Kodagoda, Watford (GB); Helen Kimber, Brighton (GB)

(21) Appl. No.: 19/374,813

(22) Filed: Oct. 30, 2025

Related U.S. Application Data
(60) Provisional application No. 63/719,473, filed on Nov. 12, 2024.
(60) Provisional application No. 63/719,314, filed on Nov. 12, 2024.
(60) Provisional application No. 63/882,922, filed on Sep. 16, 2025.
(60) Provisional application No. 63/883,233, filed on Sep. 17, 2025.

(51) Int. Cl. G06F 16/3329; G07C 9/28

(52) U.S. Cl. CPC G06F 16/33295; G07C 9/28

(57) ABSTRACT

A system for generating an object-focused narrative stringing a series of events derived from a plurality of security data outputs, comprising a processor; and memory including program code that, when executed by the processor, causes the processor to identify a first security event associated to a first security data output from among the plurality of security data outputs; receive a second security data output from among the plurality of security data outputs, and identifying, based on the second security data output a second-relation event related to the first-relation event; receive a third security data output from among the plurality of security data outputs, and identifying, based on the third security data output a third-relation event related to the second-relation event; and build a story by generating a text-based narrative that describes the first-relation event, the second-relation event, and the third-relation event; a method of use thereof.

The present application claims priority from U.S. provisional patent application No. 63/719,314 filed on Nov. 12, 2024, incorporated herein by reference, U.S. provisional patent application No. 63/719,473 filed on Nov. 12, 2024, incorporated herein by reference, U.S. provisional patent application No. 63/882,922 filed on Sep. 16, 2025, incorporated herein by reference, and U.S. provisional patent application No. 63/883,233 filed on Sep. 17, 2025, incorporated herein by reference.

### TECHNICAL FIELD

The present disclosure relates to security systems, and more particularly to arranging and presenting information derived from a security system.

### BACKGROUND

Security systems may be receiving data (security data outputs) from a plurality of security sensors, such as cameras, badge readers, motion detectors, speakers, alarm systems, licence plate readers, etc. As such, due to the quantity of data received at the security system, an operator may face challenges in sifting through this large amount of data to identify information that is relevant to an event of interest (e.g. a badge read event performed by a suspicious figure) or to an object of interest (e.g. a target vehicle, a target person, etc.) Moreover, it would be advantageous for related information to be presented to an operator of a security system in an ordered manner.

### SUMMARY

The systems and methods of the present disclosure pertain to generate a text-based narrative describing a sequence of actions corresponding to a series of related events. The identification of the related events that are described in the text-based narrative is performed iteratively, where a search that is based on a first identified event (a first-relation event) leads to another event (a second-relation event), that in turn leads to another related event (a third-related event), and so forth.

In some instances, the identified events are related to a first trigger event or to an object of interest. The trigger event or the object of interest may be identified by an operator through receipt of user input, or identified by the system that, e.g., is configured to monitor for an occurrence of the trigger event.

The present disclosure provides for a response that organizes related events for logging and investigating. The text-based narrative may be used for generating building investigations and investigation reports. The system may also provide connection between related events that may not have been evident to an operator.

Moreover, an iterative approach to locating related events, and generating a text-based narrative therefrom, may provide a user with real-time insights, where an investigation may continue to proceed in real time as new events occur, as security data outputs are generated. As such, a focus of the text-based narrative may shift as events occur and security data outputs are generated.

A broad aspect is a method for generating a text-based narrative stringing a series of events derived from a plurality of security data outputs generated by a plurality of security sensors. The method includes identifying a first-relation event associated to a security sensor of the plurality of security sensors and to an object of interest or a trigger event; analyzing the plurality of security data outputs to identify second-relation events related to the plurality of security data outputs that are connected to the first-relation event; and generating the text-based narrative that describes a sequence of actions describing the first-relation event and the second-relation events.

In some embodiments, the plurality of security data outputs may be received at respective times over a period of time, wherein the second-relation events may be identified iteratively as the security data outputs are received, and wherein the text-based narrative may be generated through a modification of the sequence of actions over the period of time to add description of the second-relation events as the second-relation events are identified.

In some embodiments, the method may include analyzing the plurality of media sources to identify third-relation events related to the plurality of media sources that are connected to at least one of the second-relation events and to the object of interest, wherein the generated text-based narrative includes a sequence of actions describing the first-relation event, the second-relation events and the third-relation events.

In some embodiments, the first-relation event and the second-relation events may be linked by a first characteristic that is different from a second characteristic that links the second-relation events and the third-relation events.

In some embodiments, the first characteristic may be an object of interest.

In some embodiments, the first-relation event and the second-relation events may be described chronologically in the text-based narrative.

In some embodiments, the method may include identifying an object of interest, wherein the first-relation event may correspond to the object of interest, and wherein the second-relation events may be further related to the object of interest.

In some embodiments, the identifying of the object of interest may be based on received user input.

In some embodiments, the method may include receiving user input to select a new object of interest from objects identified in the text-based narrative; identifying a first-relation event associated to a security sensor of the plurality of security sensors and to the new object of interest; analyzing the plurality of security data outputs to identify second-relation events related to the plurality of security data outputs that are connected to the first-relation event and to the new object of interest; and generating the new text-based narrative that describes a sequence of actions describing the first-relation event and the second-relation events.

In some embodiments, the object of interest may be identified as a selected object recognized in an image stream.

In some embodiments, the recognizing may be performed by an artificial intelligence model.

In some embodiments, the security data outputs may include an image stream, and wherein at least one of the first-relation event and the second-relation events may be identified on the basis of object recognition in the image stream to identify the object of interest appearing in the image stream by identifying a signature for the object of interest appearing in the image stream.

In some embodiments, the method may include applying a selection criterion to perform a pre-selection of events related to the plurality of security data outputs, wherein the first-relation event and the second-relation events may be further selected based on the applied selection criterion.

In some embodiments, the selection criterion may be based on a time of occurrence of an event.

In some embodiments, the method may include applying a selection criterion to perform a selection of security data outputs, resulting in a subset of security data outputs, wherein the first-relation event may be related to a security data output of the subset of security data outputs, and the second-relation events may be related to the subset of security data outputs.

In some embodiments, the method may include receiving as user input a selection of additional events; and modifying the text-based narrative to include the selection of additional events in the sequence of actions of the text-based narrative.

In some embodiments, the method may include marking certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the method may include identifying an initial trigger event, wherein the first-relation event may correspond to the trigger, and wherein the second-relation events may further correspond to the trigger event.

Another broad aspect is a method for generating an object-focused narrative stringing a series of events derived from a plurality of security data outputs generated by a plurality of security sensors. The method includes identifying a first security event associated to a first security data output from among the plurality of security data outputs; receiving a second security data output from among the plurality of security data outputs, and identifying, based on the second security data output, a second-relation event related to the first-relation event; receiving a third security data output from among the plurality of security data outputs, and identifying, based on the third security data output, a third-relation event related to the second-relation event; and building a story by generating a text-based narrative that describes a sequence of actions describing the first-relation event, the second-relation event, and the third-relation event.

In some embodiments, the first-relation event and the second-relation event may be related by a first characteristic that is different from a second characteristic that relates the second-relation event and the third-relation event.

In some embodiments, the first characteristic may be an object of interest, and wherein the second characteristic may be an object of interest.

In some embodiments, the first-relation event and the second-relation event may be related by a first characteristic that also relates the second-relation event and the third-relation event.

In some embodiments, the first characteristic may be one of an object of interest; and positional information related to a location.

In some embodiments, the first-relation event, the second-relation event and the third-relation event may be described chronologically in the text-based narrative.

In some embodiments, the method may include identifying an object of interest, wherein the first-relation event may correspond to the object of interest.

In some embodiments, the method may include applying a selection criterion to perform a selection of security data outputs, resulting in a subset of security data outputs, wherein the first-relation event may be related to a security data output of the subset of security data outputs, the second-relation event may be related to the subset of security data outputs, and the third-relation event may be related to the subset of security data outputs.

In some embodiments, the method may include receiving as user input a selection of additional events; and modifying the text-based narrative to include the selection of additional events in the sequence of actions of the text-based narrative.

In some embodiments, the method may include marking certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the LLM may be GPT.

Another broad aspect is a system for generating a text-based narrative stringing a series of events derived from a plurality of security data outputs generated by a plurality of security sensors. The system includes a processor; and memory including program code that, when executed by the processor, causes the processor to: identify a first-relation event associated to a security sensor of the plurality of security sensors and to an object of interest or a trigger event; analyze the plurality of security data outputs to identify second-relation events related to the plurality of security data outputs that are connected to the first-relation event; and generate the text-based narrative that describes a sequence of actions describing the first-relation event and the second-relation events.

In some embodiments, the plurality of security data outputs may be received at respective times over a period of time, wherein the second-relation events may be identified iteratively as the security data outputs are received, and wherein the text-based narrative may be generated through a modification of the sequence of actions over the period of time to add description of the second-relation events as the second-relation events are identified.

In some embodiments, the program code may further cause the processor to analyze the plurality of media sources to identify third-relation events related to the plurality of media sources that are connected to at least one of the second-relation events and to the object of interest, wherein the generated text-based narrative may include a sequence of actions describing the first-relation event, the second-relation events and the third-relation events.

In some embodiments, the first-relation event and the second-relation events may be linked by a first characteristic that is different from a second characteristic that links the second-relation events and the third-relation events.

In some embodiments, the first characteristic may be an object of interest.

In some embodiments, the first-relation event and the second-relation events may be described chronologically in the text-based narrative.

In some embodiments, the program code may further cause the processor to identify an object of interest, wherein the first-relation event may correspond to the object of interest, and wherein the second-relation events may be further related to the object of interest.

In some embodiments, the identifying of the object of interest may be based on received user input.

In some embodiments, the program code may further cause the processor to: receive user input to select a new object of interest from objects identified in the text-based narrative; identify a first-relation event associated to a security sensor of the plurality of security sensors and to the new object of interest; analyze the plurality of security data outputs to identify second-relation events related to the plurality of security data outputs that are connected to the first-relation event and to the new object of interest; and generate the new text-based narrative that describes a sequence of actions describing the first-relation event and the second-relation events.

In some embodiments, the object of interest may be identified as a selected object recognized in an image stream.

In some embodiments, the recognizing may be performed by an artificial intelligence model.

In some embodiments, the security data outputs may include an image stream, and wherein at least one of the first-relation event and the second-relation events may be identified on the basis of object recognition in the image stream to identify the object of interest appearing in the image stream by identifying a signature for the object of interest appearing in the image stream.

In some embodiments, the program code may further cause the processor to apply a selection criterion to perform a pre-selection of events related to the plurality of security data outputs, wherein the first-relation event and the second-relation events may be further selected based on the applied selection criterion.

In some embodiments, the selection criterion may be based on a time of occurrence of an event.

In some embodiments, the program code may further cause the processor to apply a selection criterion to perform a selection of security data outputs, resulting in a subset of security data outputs, wherein the first-relation event may be related to a security data output of the subset of security data outputs, and the second-relation events may be related to the subset of security data outputs.

In some embodiments, the program code may further cause the processor to receive as user input a selection of additional events; and modify the text-based narrative to include the selection of additional events in the sequence of actions of the text-based narrative.

In some embodiments, the program code may further cause the processor to mark certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the program code may further cause the processor to identify an initial trigger event, wherein the first-relation event may correspond to the trigger, and wherein the second-relation events may further correspond to the trigger event.

Another broad aspect system for generating an object-focused narrative stringing a series of events derived from a plurality of security data outputs generated by a plurality of security sensors. The system a processor; and memory including program code that, when executed by the processor, causes the processor to: identify a first security event associated to a first security data output from among the plurality of security data outputs; receive a second security data output from among the plurality of security data outputs, and identifying, based on the second security data output a second-relation event related to the first-relation event; receive a third security data output from among the plurality of security data outputs, and identifying, based on the third security data output a third-relation event related to the second-relation event; and build a story by generating a text-based narrative that describes a sequence of actions describing the first-relation event, the second-relation event, and the third-relation event.

In some embodiments, the first-relation event and the second-relation event may be related by a first characteristic that is different from a second characteristic that relates the second-relation event and the third-relation event.

In some embodiments, the first characteristic may be an object of interest, and wherein the second characteristic may be an object of interest.

In some embodiments, the first-relation event and the second-relation event may be related by a first characteristic that also relates the second-relation event and the third-relation event.

In some embodiments, the first characteristic may be one of: an object of interest; and positional information related to a location.

In some embodiments, the first-relation event, the second-relation event and the third-relation event may be described chronologically in the text-based narrative.

In some embodiments, the program code may further cause the processor to identify an object of interest, wherein the first-relation event may correspond to the object of interest.

In some embodiments, the program code may further cause the processor to apply a selection criterion to perform a selection of security data outputs, resulting in a subset of security data outputs, wherein the first-relation event is related to a security data output of the subset of security data outputs, the second-relation event is related to the subset of security data outputs, and the third-relation event is related to the subset of security data outputs.

In some embodiments, the program code may further cause the processor to receive as user input a selection of additional events; and modify the text-based narrative to include the selection of additional events in the sequence of actions of the text-based narrative.

In some embodiments, the program code may further cause the processor to mark certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the LLM may be GPT.

Another broad aspect is a non-transitory computer-readable medium having stored thereon program instructions for generating a text-based narrative stringing a series of events derived from a plurality of security data outputs generated by a plurality of security sensors, the program instructions executable by a processing unit for: identifying a first-relation event associated to a security sensor of the plurality of security sensors and to an object of interest or a trigger event; analyzing the plurality of security data outputs to identify second-relation events related to the plurality of security data outputs that are connected to the first-relation event; and generating the text-based narrative that describes a sequence of actions describing the first-relation event and the second-relation events.

In some embodiments, the plurality of security data outputs may be received at respective times over a period of time, wherein the second-relation events may be identified iteratively as the security data outputs are received, and wherein the text-based narrative may be generated through a modification of the sequence of actions over the period of time to add description of the second-relation events as the second-relation events are identified.

In some embodiments, the program instructions may be further executable by a processing unit for analyzing the plurality of media sources to identify third-relation events related to the plurality of media sources that are connected to at least one of the second-relation events and to the object of interest, wherein the generated text-based narrative includes a sequence of actions describing the first-relation event, the second-relation events and the third-relation events.

In some embodiments, the first-relation event and the second-relation events may be linked by a first characteristic that is different from a second characteristic that links the second-relation events and the third-relation events.

In some embodiments, the first characteristic may be an object of interest.

In some embodiments, the first-relation event and the second-relation events may be described chronologically in the text-based narrative.

In some embodiments, the program instructions may be further executable by the processing unit for identifying an object of interest, wherein the first-relation event may correspond to the object of interest, and wherein the second-relation events may be further related to the object of interest.

In some embodiments, the identifying of the object of interest may be based on received user input.

In some embodiments, the program instructions may be further executable by a processing unit for: receiving user input to select a new object of interest from objects identified in the text-based narrative; identifying a first-relation event associated to a security sensor of the plurality of security sensors and to the new object of interest; analyzing the plurality of security data outputs to identify second-relation events related to the plurality of security data outputs that are connected to the first-relation event and to the new object of interest; and generating the new text-based narrative that describes a sequence of actions describing the first-relation event and the second-relation events.

In some embodiments, the object of interest may be identified as a selected object recognized in an image stream.

In some embodiments, the recognizing may be performed by an artificial intelligence model.

In some embodiments, the security data outputs may include an image stream, and wherein at least one of the first-relation event and the second-relation events may be identified on the basis of object recognition in the image stream to identify the object of interest appearing in the image stream by identifying a signature for the object of interest appearing in the image stream.

In some embodiments, the program instructions may be further executable by a processing unit for applying a selection criterion to perform a pre-selection of events related to the plurality of security data outputs, wherein the first-relation event and the second-relation events may be further selected based on the applied selection criterion.

In some embodiments, the selection criterion may be based on a time of occurrence of an event.

In some embodiments, the program instructions may be further executable by a processing unit for applying a selection criterion to perform a selection of security data outputs, resulting in a subset of security data outputs, wherein the first-relation event may be related to a security data output of the subset of security data outputs, and the second-relation events may be related to the subset of security data outputs.

In some embodiments, the program instructions may be further executable by a processing unit for: receiving as user input a selection of additional events; and modifying the text-based narrative to include the selection of additional events in the sequence of actions of the text-based narrative.

In some embodiments, the program instructions may be further executable by a processing unit for marking certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the program instructions may be further executable by a processing unit for identifying an initial trigger event, wherein the first-relation event may correspond to the trigger event, and wherein the second-relation events further correspond to the trigger event.

Another broad aspect is a non-transitory computer-readable medium for generating an object-focused narrative stringing a series of events derived from a plurality of security data outputs generated by a plurality of security sensors, comprising identifying a first security event associated to a first security data output from among the plurality of security data outputs; receiving a second security data output from among the plurality of security data outputs, and identifying, based on the second security data output a second-relation event related to the first-relation event; receiving a third security data output from among the plurality of security data outputs, and identifying, based on the third security data output a third-relation event related to the second-relation event; and building a story by generating a text-based narrative that describes a sequence of actions describing the first-relation event, the second-relation event, and the third-relation event.

In some embodiments, the first-relation event and the second-relation event may be related by a first characteristic that is different from a second characteristic that relates the second-relation event and the third-relation event.

In some embodiments, the first characteristic may be an object of interest, and wherein the second characteristic may be an object of interest.

In some embodiments, the first-relation event and the second-relation event may be related by a first characteristic that also relates the second-relation event and the third-relation event.

In some embodiments, the first characteristic may be one of: an object of interest; and positional information related to a location.

In some embodiments, the first-relation event, the second-relation event and the third-relation event may be described chronologically in the text-based narrative.

In some embodiments, the program instructions may be further executable by a processing unit for identifying an object of interest, wherein the first-relation event may correspond to the object of interest.

In some embodiments, the program instructions may be further executable by a processing unit for applying a selection criterion to perform a selection of security data outputs, resulting in a subset of security data outputs, wherein the first-relation event is related to a security data output of the subset of security data outputs, the second-relation event is related to the subset of security data outputs, and the third-relation event is related to the subset of security data outputs.

In some embodiments, the program instructions may be further executable by a processing unit for: receiving as user input a selection of additional events; and modifying the text-based narrative to include the selection of additional events in the sequence of actions of the text-based narrative.

In some embodiments, the program instructions may be further executable by a processing unit for marking certain actions of the sequence of actions described in the text-based narrative.

In some embodiments, the marking may be performed using colour-coding.

In some embodiments, the text-based narrative may be structured in point-form, wherein a point may correspond to one of the actions of the sequence of actions.

In some embodiments, the text-based narrative may be generated by a large language model (LLM).

In some embodiments, the LLM may be GPT.

### BRIEF DESCRIPTION OF THE DRAWINGS

The invention will be better understood by way of the following detailed description of embodiments of the invention with reference to the appended drawings, in which:

FIG. 1 is a block diagram of an exemplary security system that has been adapted to generate a text-based narrative;

FIG. 2 is a block diagram of an exemplary computing device;

FIG. 3 is a block diagram of exemplary software architecture for generating a text-based narrative from security data outputs; and

FIG. 4 is a flowchart diagram of an exemplary method for generating a text-based narrative from a plurality of related events relating to security data outputs.

### DETAILED DESCRIPTION

The present disclosure relates to systems and methods for generating a text-based narrative that describes a plurality of actions corresponding to related events that are identified iteratively from a plurality of security data outputs.

The text-based narrative can assist with the operation and use of a security system receiving data from a plurality of security sensors, in order to connect information that is derived from the security data outputs generated by these security sensors in a manner that assists an operator in sifting through this information.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Exemplary Security System that is Adapted to Generate a Text-Based Narrative

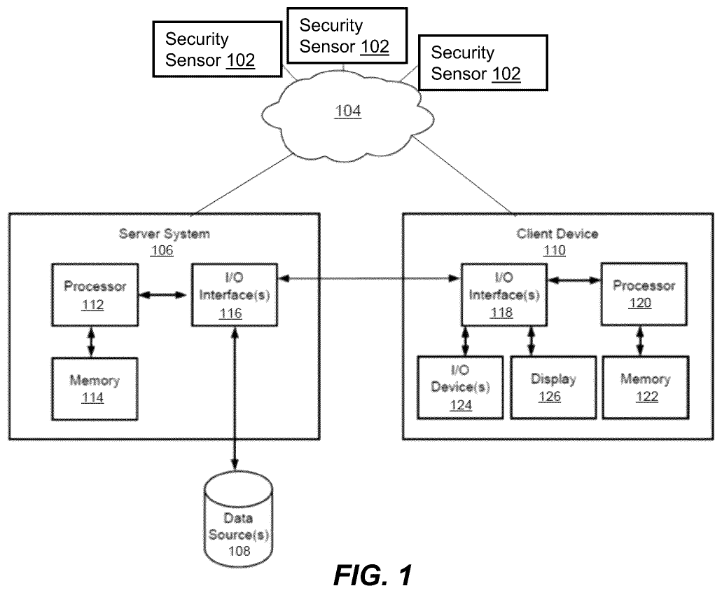

FIG. 1 illustrates an exemplary security system 100 that has been adapted to generate a text-based narrative for a sequence of actions derived from events related to security data outputs.

The system 100 has one or more security sensors 102 that generate security data outputs. For instance, an exemplary security sensor 102 may be a camera, a licence plate reader, a badge reader, a biometric sensor, a motion detector, a security alarm system, a speaker, a smoke alarm, etc. A security data output may be an image stream, a licence plate read, a motion detection, a badge read, a biometric read, a triggering of a security alarm, an audio stream, a detection of sound corresponding to a gunshot, a triggering of a smoke alarm, etc.

The security data outputs may be stored in one or more databases, such as in the data source(s) 108.

The security sensors 102 are communicatively coupled, over a network 104, to a server system 106 which is in turn in communication with one or more data sources 108. The network 104 may comprise any suitable network including, but not limited to, a Personal Area Network (PAN), Local Area Network (LAN), Wireless Local Area Network (WLAN), Metropolitan Area Network (MAN), or Wide Area Network (WAN), or combinations thereof. The server system 106 may store or archive security data outputs from the security sensors 102 (e.g., in the memory 114, in one or more of the data sources 108, etc.).

The server system 106 may be a server-based system (as shown in FIG. 1) in communication with one or multiple client devices 110 that may, in some embodiments, also be configured to access the network 104. The server system 106 is illustratively configured to obtain data related to event(s) of interest associated with the security data output(s) generated by the security sensor(s) 102. As will be discussed further below, the server system 106 is also configured to transmit the security data outputs obtained from the security sensors 102, along with any additional relevant information that may be retrieved from the data source(s) 108, to the one or more client devices 110 for presentation on a graphical user interface (GUI). In some cases, the security data outputs are transmitted directly from the security sensors 102 through the network 104 to the one or more client devices 110 for presentation on a GUI. The server system 106 may be internal or “on-site”, located in close proximity to the client device 110, for instance in the same building, or may be external or “off-site”, located remotely from the client device 110, for instance in a remote data center. The server system 106 may be a cloud-based system.

The server system 106 has at least one processor 112, memory 114, and at least one input/output (I/O) interface 116 for communication with the one or more data sources 108, and/or an I/O interface 118 of the client device 110. The one or more data sources 108 may be one or more external database(s), one or more external systems, for example, having one or more databases, that are accessible via Application Programming Interface (API) calls, and/or one or more local databases that are part of the server system 106.

The processor 112 may be a general-purpose programmable processor. In the example of FIG. 1, the processor 112 is shown as being unitary, but the processor 112 may also be multicore, or distributed (e.g. a multi-processor).

The computer readable memory 114 stores program instructions and data used by the processor 112. The computer readable memory 114 may also store locally, for instance, security data outputs, text-based narratives, etc., acting as a local database. The memory 114 may also store information regarding the data source(s) 108 that are accessible by the server system 106, such as the identity of the data sources 108, the configuration type of the data sources 108, etc. The computer readable memory 114, though shown as unitary for simplicity in the example of FIG. 1, may comprise multiple memory modules and/or caching. In particular, the memory 114 may comprise several layers of memory such as a hard drive, external drive (e.g. SD card storage) or the like and a faster and smaller Random Access Memory (RAM) module. The RAM module may store data and/or program code currently being, recently being or soon to be processed by the processor 112 as well as cache data and/or program code from a hard drive. A hard drive may store program code and be accessed to retrieve such code for execution by the processor 112 and may be accessed by the processor 112 to store and access data. The memory 114 may have a recycling architecture for storing, for instance, security data outputs, text-based narratives, information on object(s) of interest, where older data files are deleted when the memory 114 is full or near being full, or after the older data files have been stored in memory 114 for a certain time.

The I/O interface(s) 116 is in communication with the processor 112. The I/O interface(s) 116 may comprise a network interface and may be a wired or wireless interface for establishing a remote connection with, for example, a remote server, an external data source 108, the client device 110, etc. For instance, the I/O interface(s) 116 may be an Ethernet port, a WAN port, a TCP port, etc.

The processor 112, the memory 114 and the I/O interface(s) 116 may be linked via bus connections.

The data source(s) 108 may be one or more remote server(s) comprising one or more databases. A data source 108, and in particular a database, may contain security data outputs, identification information on different security sensors, etc.

In some examples, the server system 106 may have a local database stored, e.g., in memory 114, that contains text-based narratives, security data outputs, etc.

The client computing device 110 may be a remote computing device (i.e. client). One or more client computing devices 110 may be provided, in close proximity to one another, for instance located in the same office or data center, or remote from one another, for instance located in different offices and data centers dispersed across the same city or in different cities altogether.

The client computing device 110 is in communication with the I/O interface(s) 116 of the server system 106. The computing device 110 has a processor 120, a memory 122, I/O interface(s) 118 that may be linked via bus connections. The computing device 110 may have (or be connect to) any suitable I/O device(s) 124, for example, such as a keyboard, a mouse, a touchscreen, etc. The computing device 110 may be a desktop computer, a laptop, a smartphone, a tablet, etc. The computing device 110 has (or is connect to) a display 126 (e.g. a screen, a tactile display, etc.). The processor 120, the memory 122 and the I/O interface(s) 118 may be similar to the processor 112, the memory 114 and the I/O interface(s) 116, respectively.

A client application program may be stored in memory of the computing device 110 that is associated with the server system 106, the client application program providing the user with an interface to interact with the server system 106.

In some embodiments, the server system 106 may include at least one computing device 110, where, for instance, the connection between the server system 106 and the computing device 110 may be a wired connection. In some embodiments, the functionality of the server system 106 and the client computing device 110 may be implemented on a single computing device.

The client computing device 110 may be operated by user(s) to access, view, process, edit and/or analyze information associated with a security data output generated by a security sensor 102, the information received via the server system 106. The information may comprise the security data output, as well as relevant information obtained from the data source(s) 108. The client computing device 110 may be configured to launch an application (not shown) that renders a GUI on the display 126, displaying information related to the security data output. The client computing device 110 may be configured to launch a web browser or web application (not shown) that renders a GUI on the display 126. The GUI may be used to display outputs and accept inputs and/or commands from user(s) of the client computing device 110. As will be described further below, the GUI further provides user(s) with the ability to view and/or edit security data outputs, as well as be presented information of interest related to the security data outputs.

The system 100 may comprise a wide variety of different network technologies and protocols. Communication between the security sensors 102, server system 106, data source(s) 108, and client computing device 110 may occur across wired, wireless, or a combination of wired and wireless networks. The system 100 may include any number of networking devices such as routers, modems, gateways, bridges, hubs, switches, and/or repeaters, among other possibilities, communicatively coupled to the security sensors 102, server system 106, data source(1) 108, client computing device 110 and/or at any point along network 104.

A client application program may be stored in memory of the computing device 110 that is associated with the system 106, the client application program providing the user with an interface to interact with the system 106. The client application program may generate the graphical user interface, with a video feed and/or a digital map, on the display 126 of the client computing device 110.

In some embodiments, the system 106 may include at least one computing device 110, where, for instance, the connection between the system 106 and the computing device 110 may be a wired connection or a wireless connection. In some embodiments, the functionality of the system 106 and the client computing device 110 may be implemented on a single computing device.

It will be understood that in some embodiments, there may be no client-server relationship between the computing device 110 and the server system 106.

### Exemplary Software Architecture for Generating Text-Based Narrative from Security Data Outputs

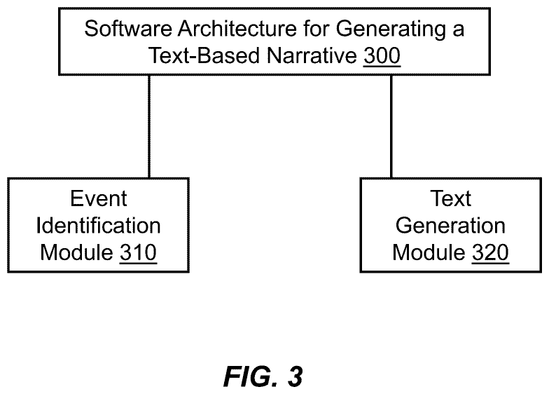

Reference is now made to FIG. 3, illustrating exemplary software architecture 300 of the server system 106 for generating a text-based narrative from security data outputs.

For purposes of illustration, the system 106 is described herein as having program code, stored in memory 101, that includes the event identification module 310 and the text generation module 320. Each of the event identification module 310 and the text generation module 320 includes program code configured to implement the functionality of the modules as are described herein.

The event identification module 310 includes program code stored in memory 114 that, when executed by the processor 112, causes the processor 112 to perform a first analysis to identify a first-relation event related to a received or retrieved security data output. In some instances, the event identification module 310 causes the processor 112 to receive an object of interest that is a subject of the analysis to identify a first-relation event that is related to the object of interest. The object of interest may be received following the receipt of user input identifying the object of interest, the system 106 identifying the object of interest as being a target for the text-based narrative, etc. In some examples, the system 116 may identify or receive a trigger event that is the basis of the analysis to identify the first-relation event, where the first-relation event is related to the trigger event. The trigger event may be identified or received following the receipt of user input selecting the trigger event, or the system 106 may identify the trigger event as being of interest.

The event identification module 310 causes the processor 112 to identify a second-relation event from received security media output that is based, at least in part, on the first-related event (and in some cases, related to the received trigger event or object of interest). The event identification module 310 may cause the processor 112 to identify a third-relation event from received security media output that is based at least in part on the second-relation event (and in some cases, related to the received trigger event or object of interest) (and in some instances, also based on the first-relation event).

The event identification module 310 may cause the processor 112 to communicate with the security sensor(s) 102 by performing application programming interface (API) calls.

By “first-relation event”, “second-relation event”, “third-relation event”, etc., the degree of the relation for the event (“first”, “second”, “third”, “fourth”, etc.) is based on the number for the search or identification process that leads to the identification of the event of interest. For searches “two, “three”, “four”, and so forth, they are based on the results or events identified in the previous search. For instance, event(s) located after a first search result in the identification of “first-relation event(s)”. For instance, event(s) located after a second search result, based on the first-relation event, in the identification of “second-relation event(s)”. For instance, event(s) located after a third search result, based on the second-relation event, in the identification of “third-relation event(s)”, etc.

The event identification module 310 may then cause the processor 112 to transmit the identified events (first-relation events, second-relation events, third-relation events, etc.) to the text generation module 320, and to call the text generation module 320 to generate a text-based narrative from the received events.

The text generation module 320 includes program code stored in memory 114 that causes the processor 112, when executed by the processor 112, to receive the event information from the event identification module 310 and to generate a story that is a text-based narrative describing a sequence of actions corresponding to the events identified by and received from the event identification module 310. The text-based narrative provides a description of the related events. The text-based narrative may be structured chronologically (determined from time parameters providing information on a time of occurrence of the event), based on an order of receipt of the events from the event identification module 310, etc. The text-based narrative may be in point-form, as a flowing text with full sentences, etc.

In some instances, the text generation module 320 may cause the processor 112 to receive user input identifying further events to be included in the text-based narrative, and the text-based narrative is modified to include a description for the sequence of actions corresponding to the received events. In some instances, the text generation module 320 may cause the processor 112 to receive user input identifying events, from the events received from the event identification module 310, to exclude from the text-based narrative, and the text-based narrative is modified to exclude from the text-based narrative the description for the sequence of actions corresponding to the events to be excluded, based on the received user input.

In some instances, the text generation module 320 may cause the processor to mark (e.g. identify or highlight) text corresponding to certain events within the text-based narrative (e.g. through the use colour, font changes, putting the text in bold, underlining the text, etc.)

In some instances, the text generation module 320 may include program code for, or to call (through an application programming interface (API) call), an artificial intelligence module (e.g. a large language model) that is trained to generate a text based on received information on the events identified by the event identification module 310.

### Exemplary Method of Generating a Text-Based Narrative Based from Security Data Outputs

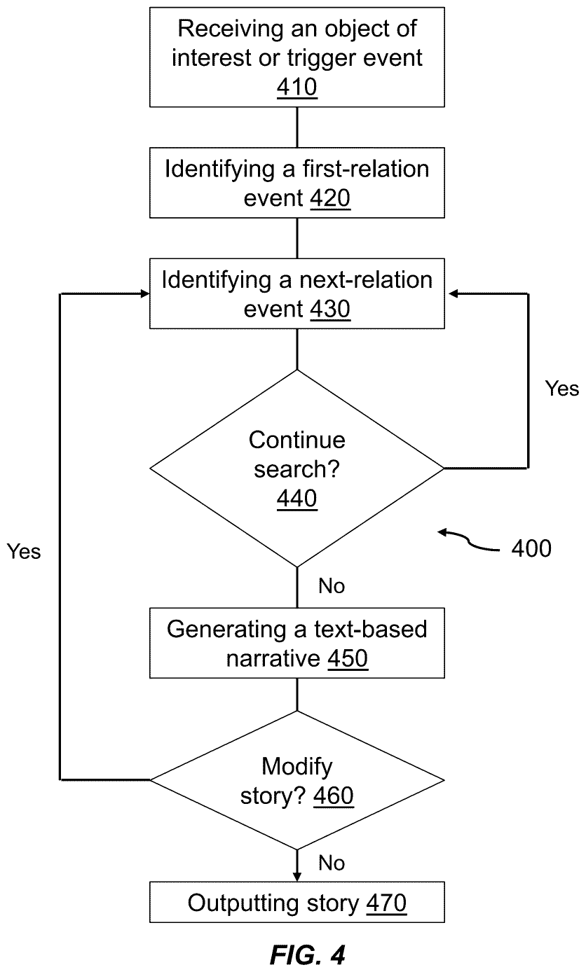

Reference is now made to FIG. 4, illustrating an exemplary method 400 of generating a text-based narrative from security data outputs. The method may be performed by system 106, or any other system in accordance with the present teachings.

In some instances, an object of interest or a trigger event may be received at step 410. In some instances, user input is received selecting an object of interest or a trigger event. For example, the user input may include a selection (e.g. a mouse ‘click’ or press of a touchscreen) of an object appearing in and/or recognized in an image frame of an image stream. In some instances, the system selects an object of interest or a trigger event that is then received at step 410 (for instance, the system may be implementing a monitoring protocol, where the system identifies an object of interest or a trigger event that meets a number of set parameters, thereby selecting the object of interest or the trigger event that meets those parameters). For instance, user input may be provided as a string of characters, a voice command, touches on a touchscreen, etc.

In some instances, search parameters may be provided (e.g. as user input) to define characteristics for identifying the trigger event, or the first-relation event. For instance, the search parameters may identify geographical parameters or a time window, where the identified trigger event or first-relation event corresponds to the geographical parameters and/or time window.

A first-relation event is identified at step 420 from a received security data output. The security data outputs may be pushed by the security sensors that generated the security data outputs. An API call may be performed to communicate with a sensory sensor to cause a transmission of the security data output generated by the sensory sensor. Exemplary security sensors, followed by the security data output that they generate, may include, but are not limited to:
cameras, generating image frames or image streams;
licence plate readers, generating licence plate readings;
motion detectors, generating motion detection readings;
security alarm systems, generating messages of a triggering of an alarm;
smoke detector systems, generating messages of a detection of smoke;
microphones, generating readings of au audio of a certain quality (e.g. above a certain threshold, of a predefined audio pattern, etc.) or audio files;
badge readers, generating badge readings;
biometric readers, generating biometric reads;
a video analytics module or micro-server, generating analytics on video feeds;
etc.

Exemplary events may include, for instance, door force open alarm event, licence plate on a hit list read (e.g. based on a wanted list), video analytics detect piggy backing (in some instances, in conjunction with badge reader data, such as when two individuals cross a badge reader but only one badge reader occurs), lost luggage detection. In some instances, the generating of an event may be user-instigated, through the receipt of user input by the user (e.g. such as by selecting a button identified as “investigate”).

In examples where an object of interest or trigger event is received at step 410, the first-relation event that is identified may be related to the received object of interest or trigger event. For instance, if the object of interest has a vector image signature in an image frame, a search may be performed to locate object(s) with that vector or signature in the security data output that is an image stream. The locating of the object in the image stream may be the first-relation event.

The first-relation event may be identified from a received security data output without first receiving an object of interest or a trigger event. In these instances, the first-relation event may be the event that has been identified or that is identified in the received security data output. For instance, when the security data output is an audio file, the first-relation event may be the detection of an audio pattern corresponding to a gunshot, where the first-relation event is a gunshot event. For instance, when the security data output is a badge reading, the first-relation event is the badge reading event that corresponds to the badge reading information received from the badge readers.

A second-relation event is identified at step 430, from a security data output, that is related to the first-relation event. In some examples, when an object of interest or a trigger event is received at step 410, the second-relation event may be related to the first-relation event and to the object of interest (or to the trigger event).

In some instances, a plurality of second-relation events may be identified from one more security data outputs.

The second-relation event is identified by performing a search for events identified in security data outputs that have a relationship to the first-relation event. In some instance, that relationship is defined by a user or by the system. For instance, that relationship may be that both the first-relation event and second-relation event pertain to an object of interest (e.g. an object of a person identified in two image streams, a first image stream that is the basis for the first-relation event, and a second image stream that is the basis for the second-relation event). In some instances, that relationship between the first-relation event and the second-relation event may be a common location (as determined from location parameters, such as Global Positioning System (GPS) coordinates, that may be associated with the event identified in the security data output, associated with the security sensor that generated the security data output, etc.) It will be understood that other relationships may exist and be searched for between the first-relation event and the second-relation event, to identify the second-relation event(s).

In some instances, objects related to the first-relation event, and/or any other subsequent-relation event, may be identified (e.g. persons, vehicles, etc.) by performing a search within the security data output(s) for objects matching defined search parameters surrounding the first-relation event, and/or any other subsequent-relation event, or image frame of interest. The defined search parameters may include, but are not limited to, geographical parameters, temporal parameters, object types, etc.

In some embodiments, a security data output (e.g. a video stream) may be analyzed to identify objects identified in the security data output. Timestamps may be generated for the object and related to the security data output (e.g. and added as metadata to the security data output) indicative of when an object is present (e.g. visible) in the security data output, and no longer present (e.g. no longer visible) in the security data output. Further information may be stored as metadata with the security data output regarding the object's identity, such as the type of object, an identifier for the object, a colour found on the object, etc.

In some implementations, a profile data structure is generated for object(s) recognized in the security data output (e.g. the video stream) (e.g. and stored as metadata associated with the security data output), the profile data structure defining a list of features (e.g. as fields) related to the recognized object, such as an identifier for the object (e.g. a name, licence plate, vehicle model, etc.), a type of object (e.g. a person, a vehicle, a dog, a cat, etc.), features of the object (e.g. for a person: gender, height, colour of clothing, shape etc. ; for a vehicle: model, year, colour, etc.). A query may then be performed starting from an object appearing in a security data output, from the profile data structure corresponding to the target object, to identify other security data outputs associated with profile data structure(s) that match or have a defined degree of similarity with the profile data structure of the target object appearing in the present security data output. The queried security data outputs may be retrieved for analysis, e.g., by a user.

An analysis of the identified chain of related events may be performed at step 440 to determine if further identification of related events found in security data outputs is to be performed. If further identification of related events is to be performed, then the step 430 of identifying a next-relation event is performed. If the prior performance of step 430 led to the identification of one or more second-relation events, then the next performance of step 430 leads to the identification of one or more third-relation events. If the prior performance of step 430 led to the identification of one or more third-relation events, then the next performance of step 430 leads to the identification of one or more fourth-relation events, and so forth.

User input may be received to perform a further search at step 440, where a user may seek to obtain more information on a sequence of events. User input may also be received at step 440 to end the search, and no longer perform further identification of related events at step 430.

In some instances, the system may be configured to determine if further identification of related events is to be performed at step 430, or if the identification of related events is to stop (e.g. where a threshold value may be set for a number of related events to identify in a sequence, and passing that threshold value leads to an end of that search at step 440; the search may end at step 440 when all of the available security data outputs meeting certain parameters have been analyzed to determine relevant relationships, etc.)

It will be understood that a relationship between the first-relation event and the second-relation ship, between the second-relation event and the third-relation event, the third-relation event and the fourth-relation event, the fourth-relation event and the fifth-relation event, and so forth, may be, for each two relationships, the same or different.

In some instances, one or more selection criteria may be applied when performing the identification at step 420 and/or the identification performed at one or more of the iterations at step 430 to refine the events defined from the security data outputs to a subset of events that meet the one or more selection criteria. Exemplary selection criteria include, but are not limited to, a defined period of time, a defined geographical region, one or more types of events (e.g. licence plate read events, badge read events, etc.), etc.

In some instances, one or more selection criteria may be applied when performing the identification at step 420 and/or the identification performed at one or more of the iterations at step 430 to refine the security data outputs to a subset of security data output that meet the one or more selection criteria, from which the related events will be identified. Exemplary selection criteria include, but are not limited to, a defined period of time during which the security data outputs have been generated, a defined geographical region in which the security sensor that generated the security data output is generated, one or more types of security data outputs (e.g. licence plate reads, video streams, audio files, etc.), etc.

A story that is a text-based narrative is generated at step 450, describing a sequence of actions corresponding to the identified related events (identified by performing step 420 and step(s) 430). In some examples, the text-based narrative is generated following a determination at step 440 to not pursue any further searches. In some examples, the text-based narrative is generated iteratively as the related events are identified by performing step 420 and step(s) 430.

The text-based narrative is a sequence of characters. The text-based narrative may be formatted in point-form (e.g. where each point corresponds to one identified related event). In some instances, the text-based narrative is structured as a text with grammatically complete sentences and paragraphs. In some instances, the text-based narrative may be generated as an investigation file, where the events are entered into the investigation file.

In some instances, identified events may be stored as event files, where metadata may be generated that refer to the related security data output(s). The story may be presented as a case file, where icons may be used to represent identified events. In some instances, the generated story may be adapted to include interactive components, where selecting portions of the story (e.g. highlighted text, icons, etc.) may cause an action (e.g. a display of additional information corresponding to the selected component of the story). In some instances, the selection of a component of the story may cause a modification of the text under step 460, where the selection that is an object of interest or an event may cause further searches under step 430 to identify more events related to the selected component of the story.

In some examples, for each identified related event, the text-based narrative may provide identification information on the related event (e.g. an identifier for the security sensor that is the source of the security data output from which the related event was identified, a timestamp for the related event, geographical information for the related event, etc.)

In some examples, when a trigger event or object of interest is received at step 410, the text-based narrative may be drafted in relation to the trigger event or the object of interest, or from the perspective of the object of interest (where each related event is tied to the trigger event or the object of interest).

In some instances, an appearance of the text-based narrative may be marked, e.g., modified to emphasize, or distinguish, information found in the text-based narrative. For instance, colour-coding, use of a bold font, of different, fonts, of upper-case letters, subscript or superscript letter, underlining, highlighting, etc., may be used to emphasize or distinguish portion(s) of the text-based narrative from other portion(s) of the text-based narrative. For instance, information may be distinguished or emphasized based on time of occurrence of the related events described in the text-based narrative, based on location of the related events described in the text-based narrative, based on a type of related event described in the text-based narrative, etc. For instance, related events that are licence plate read events may be described in a text that is blue, whereby text describing object recognition of a vehicle object in an image stream may be in green.

In some instances, the text-based narrative may be generated by an artificial intelligence model that has been trained to generate a text-based narrative (e.g. from a training dataset of related events), when provided as input the sequence of related events (the related event information may be inputted into the artificial intelligence model iteratively as the related events are identified, or as a set after a number of related events have been identified). In some embodiments, the artificial intelligence model may be a large language model (LLM). In some instances, the artificial intelligence model may be GPT. An API call may be performed to the artificial intelligence model, through which the instructions are communicated to the artificial intelligence model to generate the text-based narrative.

In some embodiments, the story that is the text-based narrative may be modified at step 460. For instance, a determination may be made that further identification of related events is to be performed, where steps 430-450 may be repeated.

User input may be received to perform a further search at step 460, where a user may seek to obtain more information on a sequence of events. User input may also be received at step 460 to end the search, where the story may be outputted at step 470.

In some instances, the system may be configured to determine if a modification to the text-based narrative by further identifying related events is to be performed at step 460, or if the identification of related events is to stop (e.g. where a threshold value may be set for a number of related events to identify in a sequence, and passing that threshold value leads to an end of that search at step 460; when a threshold value for a number of characters or words in the text-based narrative is reached, etc.)

In some instances, user input may be received at step 460 to modify the story by removing some of the text of the text-based narrative, where the selected text to remove is deleted. In some instances, user input may be received at step 460 to modify the story by adding some text of the text-based narrative, where a sequence of characters is received as user input, the sequence of characters added to the text-based narrative.

In some instances, where an object of interest or a trigger event is received at step 410, a selection (e.g. from a user, through user input, or identified by the system) of a new object of interest or new trigger event is received, thereby causing at step 460 a repeating of steps 420-450 based on the received new object of interest or new trigger event.

In some instances, the text-based narrative may be generated with feedback input options for a user (e.g. generated on a graphical user interface displaying the text-based narrative). For instance, a first button may be labelled “not-relevant”, where a second button may be labelled “relevant”, where this combination of buttons may be linked to each text entry of event described in the text-based narrative. A user selection of “relevant” or “not-relevant” may cause a modification of the text, or may refine the search of relevant events under step 430 based on if certain texts associated with events were categorized by a user as “relevant” or “not-relevant”, following a receipt of user input with respect to the buttons made available by the system to provide the input.

When a determination is made that the text-based narrative is complete, the story that is the text-based narrative is outputted at step 470. The story may be transmitted to a client device, displaying on the display of the client device running an application program for the security system. The story may be transmitted to memory, an external database or data source, for storage.

The following example is provided to enable the skilled person to better understand the present disclosure. As it is but an illustrative and representative example, it should not limit the scope of the present disclosure. It is only added for illustrative and representative purposes. It will be understood that other examples may be used to further illustrate and represent the present disclosure without departing from the present teachings.

### EXAMPLE 1: GENERATING A TEXT-BASED NARRATIVE

A licence plate read event is identified in a security data output that is a licence plate read. The licence plate read event is the first-relation event.

A search through received security media outputs that are image streams is performed to identify licence plate objects in the image streams that match the licence plate number of the licence plate read event through character recognition.

An identification of the licence plate in one of the image streams is a second licence plate read event or object recognition event that is the second-relation event. The relationship between the first-relation event and the second-relation event is the licence plate number.

Further image analysis is performed on the image stream related to second-relation event to identify a face of the driver of the vehicle corresponding to the licence plate with the target licence plate number.

Once an object of the face of the driver is recognized in the image stream, facial recognition may be performed on the object of the face to identify the driver.

Once the identity of the driver has been determined, a further search in performed through security data outputs for image streams featuring an object of a face that matches the face identified in the image stream related to the second-relation event.

A security data output is identified featuring the object of the face of the driver, this object recognition of the person constituting a third-relation event that is related to the second-relation event through the object of the driver. An analysis of the image stream provides information that the person is located in a parking lot, next to the vehicle corresponding to the licence plate number that relates to both the first-relation event and the second-relation event.

The first-relation event, the second-relation event and the third-relation event are analyzed for generating the text-based narrative of the story. An exemplary text-based narrative is as follows (the text-based narrative may be generated iteratively as more related events are identified):
vehicle with licence plate number A348 CDK is identified by camera 123456.7 on Safe Avenue at 4:50 EST on Apr. 3, 2024;
the vehicle is found on Fast Street at 4:56 EST on Apr. 3, 2024, as viewed in video feed by camera 45123.6. The vehicle is a red Mazda™. The driver of the vehicle is identified as Bobby Butterfingers;
Bobby Butterfingers is located in Sunny Shopping parking lot at 5:04 EST on Apr. 3, 2024, as identified by camera 478901A.1. A vehicle matching the description of the vehicle with licence plate number A348 CDK is also found in the Sunny Shopping parking lot.

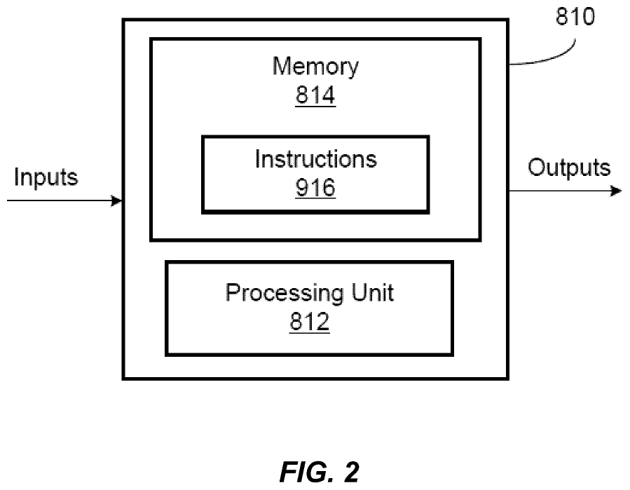

With reference to FIG. 2, the methods of the present disclosure may be implemented by one or more computing devices, such as a computing device 810 comprising a processing unit 812 and a memory 814 which has stored therein computer-executable instructions 916. Each of the system 106 and the client computing device 110 may each be implemented by and/or comprise at least one computing device, such as the computing device 810.

The processing unit 812 may comprise any suitable devices configured to implement the methods such that instructions 916, when executed by the computing device 110 or other as described herein to be executed. The processing unit 812 may comprise, for example, any type of general-purpose microprocessor or microcontroller, a digital signal processing (DSP) processor, a central processing unit (CPU), a graphical processing unit (GPU), an integrated circuit, a field programmable gate array (FPGA), a reconfigurable processor, other suitably programmed or programmable logic circuits, or any combination thereof. The processing unit 712 may be referred to as a “processor”.

The memory 814 may comprise any suitable known or other machine-readable storage medium. The memory 814 may comprise non-transitory computer readable storage medium, for example, but not limited to, an electronic, magnetic, optical, electromagnetic, infrared, or semiconductor system, apparatus, or device, or any suitable combination of the foregoing. The memory 814 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 814 may include any storage means (e.g., devices) suitable for retrievably storing machine-readable instructions 916 executable by processing unit 812.

The methods and systems described herein may be implemented in a high-level procedural or object-oriented programming or scripting language, or a combination thereof, to communicate with or assist in the operation of a computer system, for example the computing device 810. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or in some embodiments the processing unit 812 of the computing device 810, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method for generating a text-based narrative encompassing a series of events derived from a plurality of security data outputs generated by a plurality of security sensors, comprising:
identifying a first-relation event associated with a security sensor of the plurality of security sensors and with an object of interest or a trigger event;
analyzing the plurality of security data outputs to identify one or more second-relation events associated with the plurality of security data outputs that are connected to the first-relation event; and
generating the text-based narrative that describes a sequence of actions describing the first-relation event and the one or more second-relation events.

2. The method according to claim 1, wherein the plurality of security data outputs are received at respective times over a period of time, wherein the one or more second-relation events are identified iteratively as the security data outputs are received, and wherein the text-based narrative is generated through a modification of the sequence of actions over the period of time to add description of the one or more second-relation events as the one or more second-relation events are identified.

3. The method according to claim 1, further comprising analyzing the plurality of media sources to identify third-relation events related to the plurality of media sources that are connected to at least one of the one or more second-relation events and to the object of interest, wherein the generated text-based narrative describes a sequence of actions describing the first-relation event, the one or more second-relation events and the third-relation events.

4. The method according to claim 3, where the first-relation event and the one or more second-relation events are linked by a first characteristic that is different from a second characteristic that links the one or more second-relation events and the third-relation events.

5. The method according to claim 4, wherein the first characteristic is an object of interest.

6. The method according to claim 1, wherein the first-relation event and the one or more second-relation events are described chronologically in the text-based narrative.

7. The method according to claim 1, further comprising identifying an object of interest, wherein the first-relation event is associated with the object of interest, and wherein the one or more second-relation events are further associated with the object of interest.

8. The method according to claim 7, wherein the identifying of the object of interest is based on received user input.

9. The method according to claim 7, wherein the text-based narrative identifies objects, further comprising:
receiving user input to select a new object of interest from the objects identified in the text-based narrative;
identifying a first-relation event associated to a security sensor of the plurality of security sensors and to the new object of interest;
analyzing the plurality of security data outputs to identify second-relation events related to the plurality of security data outputs that are connected to the first-relation event and to the new object of interest; and
generating the new text-based narrative that describes a sequence of actions describing the first-relation event and the one or more second-relation events.

10. The method of according to claim 7, wherein the object of interest is identified as a selected object recognized in an image stream.

11. The method according to claim 7, wherein the security data outputs include an image stream, and wherein at least one of the first-relation event and the one or more second-relation events are identified on the basis of object recognition in the image stream to identify the object of interest appearing in the image stream by identifying a signature for the object of interest appearing in the image stream.

12. The method according to claim 1, further comprising applying a selection criterion to perform a pre-selection of events related to the plurality of security data outputs, wherein the first-relation event and the one or more second-relation events are further selected based on the applied selection criterion.

13. The method according to claim 12, wherein the selection criterion is based on a time of occurrence of an event.

14. The method according to claim 1, further comprising applying a selection criterion to perform a selection of security data outputs, resulting in a subset of security data outputs, wherein the first-relation event is related to a security data output of the subset of security data outputs, and the one or more second-relation events are related to the subset of security data outputs.

15. The method according to claim 1, further comprising:
receiving as user input a selection of additional events; and
modifying the text-based narrative to include the selection of additional events in the sequence of actions of the text-based narrative.

16. The method according to claim 1, further comprising marking certain actions of the sequence of actions described in the text-based narrative.

17. The method according to claim 1, wherein the text-based narrative is generated by a large language model (LLM).

18. The method according to claim 1, further comprising identifying an initial trigger event, wherein the first-relation event is associated with the initial trigger event, and wherein the one or more second-relation events is associated with the initial trigger event.

19. A system for generating a text-based narrative encompassing a series of events derived from a plurality of security data outputs generated by a plurality of security sensors, comprising:
a processor; and
memory including program code that, when executed by the processor, causes the processor to:
identify a first-relation event associated with a security sensor of the plurality of security sensors and with an object of interest or a trigger event;
analyze the plurality of security data outputs to identify one or more second-relation events associated with the plurality of security data outputs that are connected to the first-relation event; and
generate the text-based narrative that describes a sequence of actions describing the first-relation event and the one or more second-relation events.

20. A non-transitory computer-readable medium having stored thereon program instructions for generating a text-based narrative encompassing a series of events derived from a plurality of security data outputs generated by a plurality of security sensors, the program instructions executable by a processing unit for:
identifying a first-relation event associated with a security sensor of the plurality of security sensors and with an object of interest or a trigger event;
analyzing the plurality of security data outputs to identify one or more second-relation events associated with the plurality of security data outputs that are connected to the first-relation event; and
generating the text-based narrative that describes a sequence of actions describing the first-relation event and the one or more second-relation events.
